(19) United States
(12) Patent Application Publication
(10) Pub. No.: US 2025/0158547 A1
(43) Pub. Date: May 15, 2025

(54) TECHNIQUE FOR CONTROLLING MOTOR IN ELECTRIC WORK MACHINE

(71) Applicant: MAKITA CORPORATION, Anjo-shi (JP)

(72) Inventors: Masatoshi ITO, Anjo-shi (JP); Masatoshi Shinoda, Anjo-shi (JP)

(73) Assignee: MAKITA CORPORATION, Anjo-shi (JP)

(21) Appl. No.: 18/941,722

(22) Filed: Nov. 8, 2024

(30) Foreign Application Priority Data
Nov. 15, 2023 (JP) 2023-194486

(51) Int. Cl. H02P 7/22; B25F 5/02

(52) U.S. Cl. CPC H02P 7/22; B25F 5/02

(57) ABSTRACT

One aspect of the present disclosure includes an electric work machine including a motor, a first manual switch, a second manual switch, and a control circuit. The control circuit rotates the motor in accordance with a first control system, based on (i) the first manual switch being manually operated and (ii) the second manual switch being within a first region. The control circuit stops the motor, based on (i) the first manual switch not being manually operated and/or (ii) the second manual switch being within a second region. The control circuit rotates the motor in accordance with a second control system, based on (i) the first manual switch being manually operated and (ii) the second manual switch being within a third region.

### CROSS-REFERENCE TO RELATED APPLICATIONS

This application claims the benefit of Japanese Patent Application No. 2023-194486 filed on Nov. 15, 2023, with the Japan Patent Office, the disclosure of which is incorporated herein by reference.

### BACKGROUND

The present disclosure relates to a technique for controlling a motor in an electric work machine.

Japanese Patent No. 6357086 discloses a brush cutter including a trigger switch and an operation input device. The trigger switch and the operation input device are user interfaces manually operated by a user of the brush cutter. The operation input device includes a main power switch, a reverse switch, and the like. The user can switch a rotational direction of a motor and a rotational speed of the motor by manipulating the operation input device.

### SUMMARY

As functions of a brush cutter increase, its operation input device may (i) have a more complicated configuration and (ii) be required a more complicated input manipulation. Such possibilities may be applied to various electric work machines other than the brush cutter.

In one aspect of the present disclosure, it is desirable to provide an electric work machine that can selectively perform two or more functions based on easy manipulation to a user interface while inhibiting from complicating a configuration of the user interface.

One aspect of the present disclosure provides an electric work machine including a motor, a first manual switch, a second manual switch, and a control circuit.

The first manual switch is manually operated by a user of the electric work machine. The second manual switch is (i) manually operated by the user and (ii) thereby moved within a movement range. The movement range includes a first region, a second region, and a third region.

The control circuit rotates the motor in accordance with a first control system, based on (i) the first manual switch being manually operated and (ii) the second manual switch being within the first region.

The control circuit stops the motor based on (i) the first manual switch not being manually operated and/or (ii) the second manual switch being within the second region.

The control circuit rotates the motor in accordance with a second control system, based on (i) the first manual switch being manually operated and (ii) the second manual switch being within the third region. The second control system is different from the first control system.

The electric work machine configured as described above includes the first manual switch and the second manual switch as user interfaces. The user can move the second manual switch, thereby causing the motor (i) to rotate in accordance with the first control system, (ii) to rotate in accordance with the second control system, or (iii) to stop. This makes it possible to selectively perform two or more functions based on easy manipulation to a user interface while inhibiting the configuration of the user interface from being complicated.

### BRIEF DESCRIPTION OF THE DRAWINGS

An example embodiment of the present disclosure will be described hereinafter by way of example with reference to the accompanying drawings, in which:

FIG. 1 is a perspective view of an electric work machine in an embodiment;

FIG. 2 is a perspective view of a right grip and a manipulation unit;

FIG. 3 is an explanatory diagram of an operation panel;

FIG. 4 is a side view of the right grip and the manipulation unit;

FIG. 5 is a side view of the right grip and the manipulation unit in which a first half housing and a second manual switch are not shown;

FIG. 6 is a perspective view of the second manual switch, a lever supporter, and a switch box.

FIG. 7 is an explanatory diagram illustrating an electrical configuration of the electric work machine;

FIG. 8 is an explanatory diagram illustrating various states of the electric work machine in accordance with a position of the second manual switch;

FIG. 9 is a flow chart of a main power state setting process;

FIG. 10 is a flow chart of a mode switching detection process;

FIG. 11 is a flow chart of an operation mode setting process; and

FIG. 12 is a flow chart of a motor control process.

### DETAILED DESCRIPTION OF EXEMPLARY EMBODIMENTS

### 1. Overview of Embodiment

One embodiment may provide an electric work machine including at least any one of the following Features 1 to 10.
Feature 1: a motor.
Feature 2: a first manual switch (or first operation switch, or first manipulator, or first operating portion) is configured to be manually operated (or moved) by a user of the electric work machine.
Feature 3: a second manual switch (or second operation switch, or second manipulator, or second operating portion) is configured to be manually operated (or moved) by the user.
Feature 4: the second manual switch is configured to be moved within a movement range (or a movement path).
Feature 5: the movement range includes a first region (or a first range or a first path), a second region (or a second range or a second path), and a third region (or a third range or a third path).
Feature 6: a control circuit.
Feature 7: the control circuit is configured to rotate the motor in accordance with a first control system (or a first control method or a first rotation mode or a first rotation method), based on (i) the first manual switch being manually operated and (ii) the second manual switch being within the first region. Rotating the motor in accordance with the first control system may be rephrased as performing a first control operation for rotating the motor.
Feature 8: the control circuit is configured to stop the motor (or stop rotation of the motor), based on (i) the first manual switch not being manually operated and/or (ii) the second manual switch being within the second region.
Feature 9: the control circuit is configured to rotate the motor in accordance with a second control system (or a second control method or a second rotation mode or a second rotation method), based on (i) the first manual switch being manually operated and (ii) the second manual switch being within the third region. Rotating the motor in accordance with the second control system may be rephrased as performing a second control operation for rotating the motor.
Feature 10: the second control system is different from the first control system.

The electric work machine including at least Features 1 to 10 can selectively perform two or more functions, based on easy manipulation (or operation) to a user interface while inhibiting the configuration of the user interface from being complicated.

The first manual switch may include a first movable portion (or first manipulator, or first operating portion, or trigger) configured (i) to be manually operated by the user and (ii) to thereby be moved. The first manual switch being manually operated may indicate that the first movable portion is manually operated.

The second manual switch may include a second movable portion (second manipulator, or second operating portion, or lever, or dial, or slider, or selector) configured (i) to be manually operated by the user and (ii) to thereby be moved within a movement range. The second manual switch being manually operated may indicate that the second movable portion is manually operated.

The first region, the second region, and the third region may be independent from each other without overlapping each other.

The electric work machine may include a drive circuit. The drive circuit may be electrically coupled to the control circuit and the motor. The drive circuit may be configured to receive a motor control signal from the control circuit directly or through an intermediate circuit. The motor control signal is generated by the control circuit, in order to drive or stop the motor (in other words, control the motor). The drive circuit may be configured to supply an electric power to the motor or stop the supply of the electric power to the motor, in accordance with the motor control signal. The motor may receive the electric power from the drive circuit and thereby rotate. The intermediate circuit may include a gate circuit. The gate circuit may be configured to receive the motor control signal. The gate circuit may be configured to output the motor control signal to the drive circuit. The gate circuit may be configured to output, to the drive circuit, a motor drive signal corresponding to the motor control signal. In this case, the drive circuit may be configured to supply the electric power to the motor or to stop the supply of the electric power for the motor, in accordance with the motor drive signal.

In addition to or in lieu of at least any one of the above-described Features 1 to 10, one embodiment may include the following Feature 11 or Feature 12.
Feature 11: the second manual switch is configured to be moved from the first region to the third region through the second region.
Feature 12: the second manual switch is configured to be moved from the third region to the first region through the second region.

The electric work machine including at least Features 1 to 12 can more easily stop (i) the motor rotating in accordance with the first control system and (ii) the motor rotating in accordance with the second control system.

The second region may be directly connected (i.e., be adjacent) to the first region, or may be separated from the first region. The second region may be directly connected to the third region, or may be separated from the third region. The first region may be separated from the third region or may be directly connected to the third region.

In addition to or in lieu of at least any one of the above-described Features 1 to 12, one embodiment may include the following Feature 13.
Feature 13: the control circuit is configured to execute (or perform) a first stop operation to stop the motor, based on (i) the first manual switch being manually operated and (ii) the second manual switch having been moved from the first region to the third region.

The electric work machine including at least Features 1 to 10 and 13 can inhibit a rapid change of the control system.

Especially, in the electric work machine including Feature 11 and/or Feature 12, when the user moves the second manual switch from the first region to the second region in order to stop the motor, the second manual switch may inadvertently pass through the second region and enter the third region. In this case, if the motor is immediately rotated in accordance with the second control system, the user's usability may decrease. Also, in a case in which the second manual switch is moved from the third region to the second region, the second manual switch may inadvertently pass through the second region and enter the first region. In such a case, if the motor is immediately rotated in accordance with the first control system, the user's usability may decrease.

However, in the electric work machine including at least Features 1 to 13, if the second manual switch passes through the second region as described above, the motor is stopped once. Accordingly, the user's usability is inhibited from decreasing.

In addition to or in lieu of at least any one of the above-described Features 1 to 13, one embodiment may include the following Feature 14 and/or Feature 15.
Feature 14: the control circuit is configured to rotate the motor in accordance with the second control system, based on (i) the first stop operation being performed (or the first stop operation being started, or the motor being stopped by the first stop operation) and (ii) subsequently a specific operation being performed on the first manual switch.
Feature 15: the specific operation includes (i) releasing a manual operation of the first manual switch and (ii) subsequently manually operating the first manual switch.

The electric work machine including at least Features 1 to 10 and 13 to 15 allows the motor to rotate in accordance with the second control system by the specific operation, even if the second manual switch is moved from the first region to the third region and thereby the motor is stopped.

In addition to or in lieu of at least any one of the above-described Features 1 to 15, one embodiment may include the following Feature 16.
Feature 16: the control circuit is configured to execute (or perform) a second stop operation to stop the motor, based on (i) the first manual switch being manually operated and (ii) the second manual switch having been moved from the third region to the first region.

The electric work machine including at least Features 1 to 10 and 16 can inhibit a rapid change of the control system.

In addition to or in lieu of at least any one of the above-described Features 1 to 16, one embodiment may include the following Feature 17.
Feature 17: the control circuit is configured to rotate the motor in accordance with the first control system, based on (i) the second stop operation being performed (or the second stop operation being started, or the motor being stopped by the second stop operation) and (ii) subsequently the specific operation performed on the first manual switch.

The specific operation in Feature 17 may be the same as, or may be different from the specific operation in Feature 15.

The electric work machine including at least Features 1 to 10, 16, and 17 allows the motor to rotate in accordance with the first control system by the specific operation, even if the second manual switch is moved from the third region to the first region and thereby the motor is stopped.

In addition to or in lieu of at least any one of the above-described Features 1 to 17, one embodiment may include at least any one of the following Features 18 to 19.
Feature 18: the first control system includes setting a desired rotational speed (or a target rotational speed) in accordance with a position of the second manual switch within the first region.
Feature 19: the first control system includes rotating the motor at the desired rotational speed that has been set.

The desired rotational speed in Feature 19 may be the desired rotational speed that has been set in Feature 18.

In addition to or in lieu of at least any one of the above-described Features 1 to 19, one embodiment may include the following Feature 20 and/or Feature 21.
Feature 20: the first control system includes increasing a desired rotational speed with an increase in a distance between the second manual switch and the second region.
Feature 21: the first control system includes rotating the motor at a desired rotational speed.

In the electric work machine including at least Features 1 to 12, 20, and 21, the user can adjust a desired rotational speed with an excellent usability of the second manual switch.

In addition to or in lieu of at least any one of the above-described Features 1 to 21, one embodiment may include the following Feature 22 and/or Feature 23.
Feature 22: the second control system includes setting the desired rotational speed in accordance with a magnitude of a load being applied to the motor.
Feature 23: the second control system includes rotating the motor at the desired rotational speed that has been set.

The desired rotational speed in Feature 23 may be the desired rotational speed that has been set in Feature 22.

In addition to or in lieu of at least any one of the above-described Features 1 to 23, one embodiment may include at least any one of the following Features 24 to 26.
Feature 24: the second control system includes setting the desired rotational speed to a first speed, based on the magnitude of the load that is less than a threshold.
Feature 25: the second control system includes setting the desired rotational speed to a second speed, based on the magnitude of the load being greater than or equal to the threshold.
Feature 26: the second speed is greater than the first speed.

In lieu of the above-described Feature 26, one embodiment may include Feature 27 below.
Feature 27: the second speed may be smaller than the first speed.

In addition to or in lieu of at least any one of the above-described Features 1 to 27, one embodiment may include the following Feature 28.
Feature 28: a click feel generator is configured to generate a click feel in (or on) the second manual switch, in response to the second manual switch moving within the movement range having reached a specific position within the movement range.

Generating the click feel in the second manual switch may be rephrased as providing the user with the click feel through the second manual switch. Generating the click feel in the second manual switch may be rephrased as changing a force (in other words, a load, an external force, or a resistance that are applied in a direction to inhibit the second manual switch moving from being moved) required for the user to move the second manual switch.

In a case in which one embodiment includes the above-described Feature 28, the embodiment may further include any one of at least Features 29 to Feature 34.
Feature 29: the movement range includes a switching occurrence region.
Feature 30: the switching occurrence region extends from a first reference position to a second reference position.
Feature 31: the first reference position is within the second region.
Feature 32: the second reference position is within the third region.
Feature 33: the click feel generator is configured to generate the click feel in the second manual switch, in response to the second manual switch having been moved from an outside of the switching occurrence region into the switching occurrence region.
Feature 34: the click feel generator is configured to generate the click feel in response to the second manual switch having left the switching occurrence region.

In the electric work machine including the click feel generator, the user when moving the second manual switch can appropriately identify a change in a position of the second manual switch due to the click feel.

In addition to or in lieu of at least any one of the above-described Features 1 to 34, one embodiment may include the following Feature 35 and/or 36.
Feature 35: the first manual switch includes a trigger.
Feature 36: the first manual switch being manually operated includes the trigger being moved a distance greater than or equal to a specific distance from an initial position.

In other words, manually operating the first manual switch includes moving the trigger a distance greater than or equal to a specific distance from an initial position.

In addition to or in lieu of at least any one of the above-described Features 1 to 36, one embodiment may include the following Feature 37.
Feature 37: the second manual switch includes a lever configured to be pivotally moved by the user.

In addition to or in lieu of at least any one of the above-described Features 1 to 37, one embodiment may include the following Feature 38 and/or Feature 39.
Feature 38: a grip is configured to be gripped by a single hand of the user of the electric work machine.
Feature 39: the first manual switch and the second manual switch are arranged on the grip or in a vicinity of the grip to allow the user to simultaneously operate the first manual switch and the second manual switch by the single hand while gripping the grip by the single hand.

The electric work machine including at least Features 1 to 10, 38, and 39 allows the user to easily adjust rotation of the motor by the single hand.

One embodiment may provide a method for controlling a motor in an electric work machine, the method includes at least any one of the following Features 40 to 42.
Feature 40: rotating the motor in accordance with a first control system, based on (i) a first manual switch being manually operated and (ii) a second manual switch being within a first region.
Feature 41: stopping the motor, based on (i) the first manual switch not being manually operated and/or (ii) the second manual switch being within a second region.
Feature 42: rotating the motor in accordance with a second control system, based on (i) the first manual switch being manually operated and (ii) the second manual switch being within a third region.

The first through third regions may be independent from each other. The second control system may be different from the first control system.

The method including Features 40 to 42 can selectively perform two or more functions based on easy manipulation to a user interface while inhibiting a configuration of the user interface from being complicated.

Examples of the electric work machine include various job-site electric apparatuses configured to be driven by batteries and used in job-sites, such as home carpentry, manufacturing, gardening, and construction. Specifically, examples of the electric work machine include an electric power tool for masonry work, metalworking, or woodworking, a work machine for gardening, and a device for preparing an environment of a job site. More specifically, examples of the electric work machine include an electric weed whacker (or an electric brush cutter), an electric grass cutter, an electric grass trimmer, an electric hedge trimmer, an electric hammer, an electric hammer drill, an electric drill, an electric driver, an electric wrench, an electric grinder, an electric circular saw, an electric reciprocating saw, an electric jig saw, an electric cutter, an electric chain saw, an electric planer, an electric cleaner, an electric sprayer, an electric spreader, an electric dust collector, a battery-operated wheel barrow, a battery-operated bicycle, and a fan best.

In one embodiment, the control circuit may be integrated into a single electronic unit, a single electronic device, or a single circuit board.

In one embodiment, the control circuit may be a combination of two or more electronic circuits, two or more electronic units, or two or more electronic devices individually provided on or in the electric work machine.

In one embodiment, the control include a microcomputer (or a microcontroller, or a microprocessor), a wired logic, an Application Specific Integrated Circuit (ASIC), an Application Specific Standard Product (ASSP), (for example, a field programmable gate array (FPGA) programmable logic device, a discrete electronic component and/or a programmable logic device (e.g. a Field Programmable Gate Array (FPGA)) and/or a combination thereof.

Examples of the motor include a brushless motor (or brushless DC motor), a brushed DC motor, an AC motor, and a stepper motor.

In one embodiment, the above-described Features 1 to 42 may be combined in any combination.

In one embodiment, any of the above-described Features 1 to 42 may be excluded.

### 2. Specific Example Embodiment

A specific example embodiment of the present disclosure will be described below.

### 2-1. Embodiment

### (2-1-1) Outline of Electric Work Machine

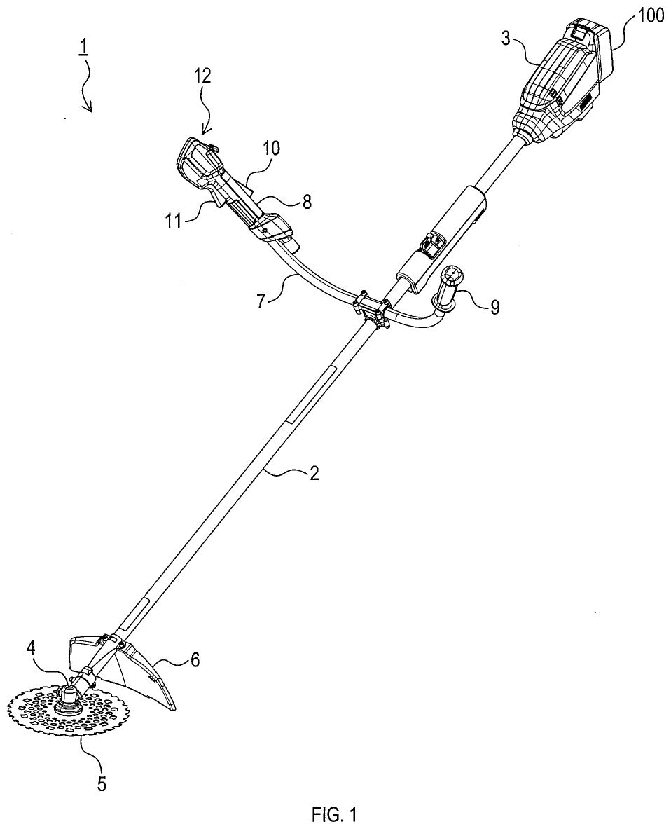

An electric work machine 1 in an embodiment shown in FIG. 1 is in the form of a brush cutter. The electric work machine 1 includes a main pipe 2. The main pipe 2 has an elongated and hollow bar-shape.

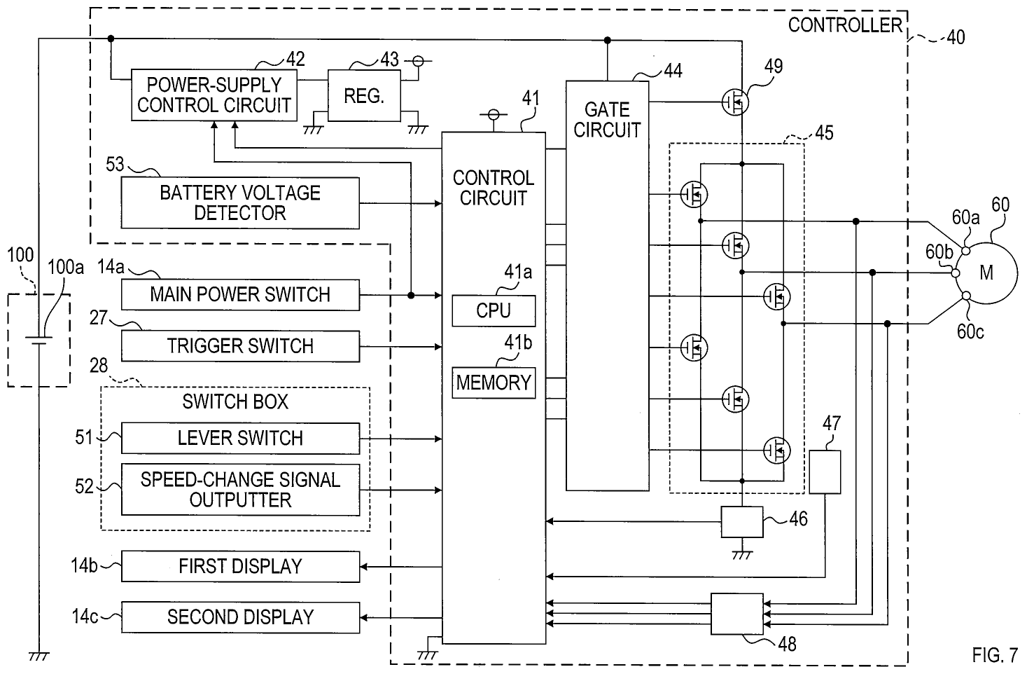

The electric work machine 1 includes a control unit 3. The control unit 3 is provided at a rear end of the main pipe 2. The control unit 3 is in the form of a hollow housing. The control unit 3 includes a battery holder in a rear end portion of the control unit 3. A battery pack 100 is detachably attached to the battery holder. The control unit 3 accommodates a controller 40 and a motor 60 (see FIG. 7), which are described below.

The battery pack 100 includes a battery 100a (see FIG. 7). The battery 100a can supply electric power (hereinafter, referred to as “battery power”) to various parts in the control unit 3. The battery 100a may be in the form of, for example, a rechargeable battery.

The electric work machine 1 includes a drive unit 4. The drive unit 4 is provided at a front end of the main pipe 2. The drive unit 4 accommodates a gear mechanism. The main pipe 2 accommodates a driving force transmission shaft (not shown). The driving force transmission shaft is coupled to the motor 60 and the gear mechanism. The driving force transmission shaft transmits a rotational force of the motor 60 (in particular, a rotor of the motor 60) to the gear mechanism.

The gear mechanism includes an output shaft (not shown). A cutting blade 5 is detachably attached to the output shaft. The cutting blade 5 is used to cut a cutting object. The cutting object includes, for example, grass and small-diameter woods. The cutting blade 5 in the present embodiment has a substantially disc-shape and includes a saw blade provided along an outer circumference of the cutting blade 5. Rotation of the motor 60 is transmitted to the output shaft via the gear mechanism. This allows the output shaft and the cutting blade 5 to rotate integrally.

The electric work machine 1 includes a cover 6. The cover 6 is provided in the vicinity of the front end of the main pipe 2. The cover 6 inhibits objects surrounding the cutting blade 5 (for example, cutting objects) from scattering toward a user of the electric work machine 1.

The electric work machine 1 includes a handle 7. The handle 7 has a U-shape. The handle 7 is coupled to the main pipe 2 in the vicinity of an intermediate position in a longitudinal direction of the main pipe 2. A first end of the handle 7 is provided with a right grip 8. A second end of the handle 7 is provided with a left grip 9. The right grip 8 is gripped by the right hand of the user. The left grip 9 is gripped with the left hand of the user.

The electric work machine 1 includes a manipulation unit (or operation unit) 12. The manipulation unit 12 is provided at a leading end of the right grip 8.

The electric work machine 1 includes a lock-off switch 10 and a first manual switch 11. In the present embodiment, the first manual switch 11 is in the form of a trigger.

The first manual switch 11 is located on a leading end part and a front part of the right grip 8. The first manual switch 11 is manually operated by the user to instruct the motor 60 to drive (i.e., rotate) or stop. The user can press the first manual switch 11 rearward (i.e., toward a side where the right grip 8 is located) by a finger (for example, an index finger) of the right hand while gripping the right grip 8 by the right hand.

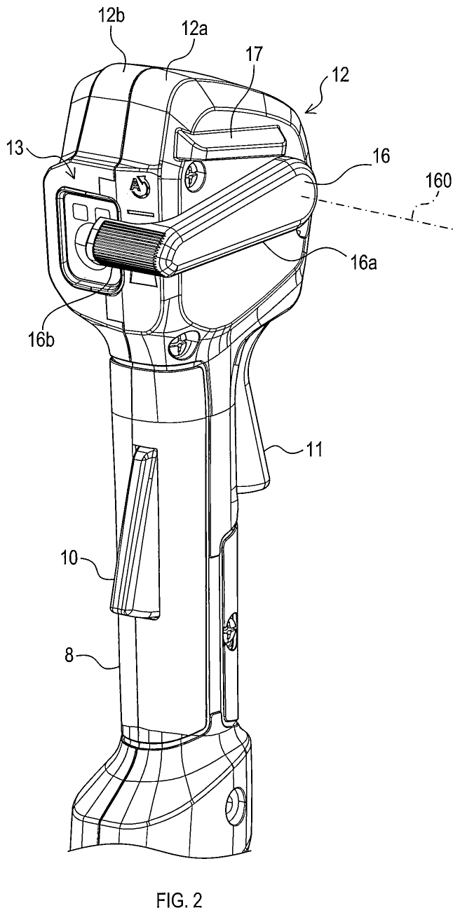

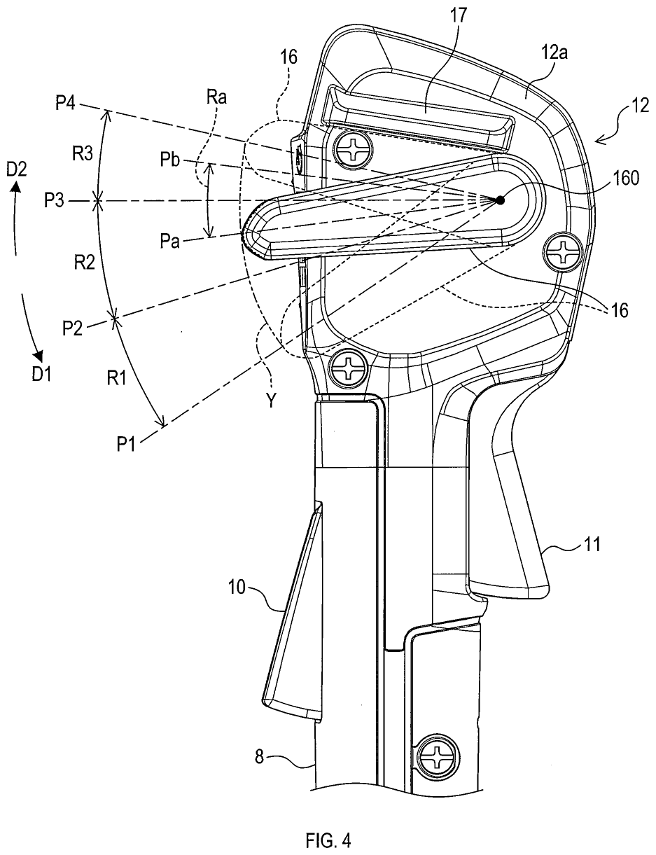

The first manual switch 11 is biased toward a front of the right grip 8 (i.e., in a direction away from the right grip 8) by a first elastic body 11a. Accordingly, when the first manual switch 11 is not touched by the user, the first manual switch 11 is located in a first initial position. FIG. 1, FIG. 2, and FIG. 4 show the first manual switch 11 located in the first initial position.

The lock-off switch 10 is located on the leading end part and a rear part of the right grip 8. The lock-off switch 10 mechanically allows, inhibits, or prevents movement of the first manual switch 11 from the first initial position to the rear.

The lock-off switch 10 is biased toward a rear of the right grip 8 (i.e., in the direction away from the right grip 8) by a second elastic body 10a. Accordingly, when the lock-off switch 10 is not touched by the user, the lock-off switch 10 is located in a second initial position. FIG. 1, FIG. 2, and FIG. 4 show the lock-off switch 10 located in the second initial position.

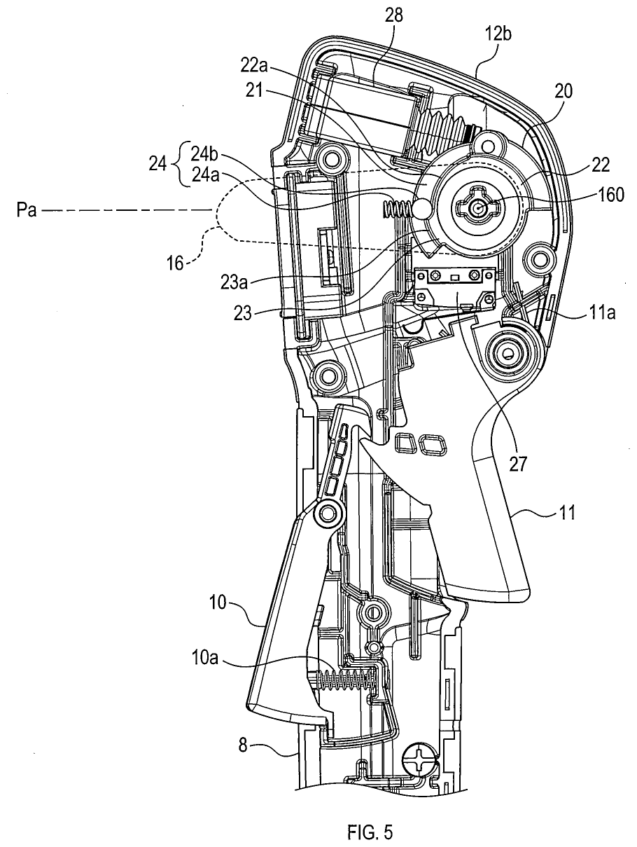

The lock-off switch 10 in the second initial position inhibits or prevents the first manual switch 11 from moving from the first initial position to the rear (i.e., being turned ON). More specifically, the lock-off switch 10 in the second initial position inhibits a trigger switch 27 (see FIG. 5 and FIG. 7) from being turned ON. The trigger switch 27 is turned ON or OFF in conjunction with the first manual switch 11. When the first manual switch 11 is located in the first initial position, the trigger switch 27 is OFF.

When the user grips the right grip 8 by the right hand, the lock-off switch 10 can be pressed frontward (specifically, toward the right grip 8) by the right hand (i.e., for example, the palm of the hand or around the base of the thumb). Accordingly, the lock-off switch 10 is moved frontward from the second initial position against an elastic force of the second elastic body 10a.

The lock-off switch 10 is moved frontward, thereby allowing the first manual switch 11 to move. Specifically, in a state in which the lock-off switch 10 has been moved frontward, if the first manual switch 11 is pressed, then the first manual switch 11 may move from the first initial position to the rear against an elastic force of the first elastic body 11a. When the first manual switch 11 is moved a distance greater than or equal to a specific distance from the first initial position to the rear, the trigger switch 27 is turned ON. The specific distance may be zero.

### (2-1-2) Manipulation Unit

With reference to FIG. 2 to FIG. 6, a specific configuration of the manipulation unit 12 will be described.

The manipulation unit 12 includes a first half housing 12a and a second half housing 12b, which are assembled with each other. The first and second half housings 12a, 12b form a single housing in the manipulation unit 12.

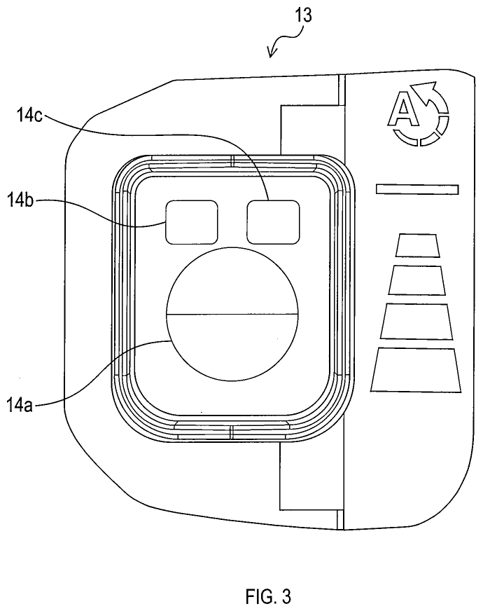

As shown in FIG. 2, the manipulation unit 12 includes an operation panel 13. As shown in FIG. 3, the operation panel 13 includes a main power switch 14a. The main power switch 14a is pressed by the user. The main power switch 14a outputs a main power signal while the main power switch 14a is being pressed. The main power switch 14a is pressed by the user to set a main power state of the electric work machine 1 (in particular, the controller 40, which will be described in detail below) to ON or OFF.

The “main power state” indicates a state of the controller 40 (see FIG. 7). Specifically, the main power state indicates a state whether the controller 40 can be operated. More specifically, the main power state indicates a state whether a described-below control circuit 41 can be operated. When the main power state is ON, various operations of the electric work machine 1 are enabled. When the main power state is OFF, the electric work machine 1 does not operate.

In the electric work machine 1 in the embodiment, each of a rotational direction and an operation mode is set. The rotational direction is set to a forward direction or a reverse direction. The operation mode is alternatively set to any one of a normal mode, an automatic speed-change mode, and a drive prohibition mode. The normal mode includes a manual speed-change mode and a stop mode. Accordingly, more specifically, the operation mode is alternatively set to any one of the manual speed-change mode, the stop mode, the automatic speed-change mode, and the drive prohibition mode.

Furthermore, the main power switch 14a is operated by the user to set the rotational direction. In an initial state of the controller 40, the rotational direction is set to the forward direction. The initial state is a state immediately after the main power state is switched ON. While the main power state is ON, the rotational direction is alternately switched each time the main power switch 14a is pressed in a first manner. When the main power state is ON and the main power switch 14a is pressed in a second manner, the main power state is switched to OFF. When the main power state is OFF and the main power switch 14a is pressed, the main power state is switched to ON.

The first and second manners may each be any phase. In the present embodiment, the first manner includes a short press, and the second manner includes a long press. The long press means to keep pressing the switch for a specified period of time. The short press means to (i) start pressing and (ii) then release the pressing before the specified period of time elapses from starting pressing.

As shown in FIG. 3, the operation panel 13 includes a first display 14b. The first display 14b in the present embodiment includes a first LED. In a case in which the main power state is set to OFF, the first display 14b does not illuminate (i.e., the first LED does not illuminate). In a case in which the main power state is set to ON, the first display 14b illuminates. In a case in which the operation mode is set to the drive prohibition mode, the first display 14b blinks.

As shown in FIG. 3, the operation panel 13 includes a second display 14c. The second display 14c in the present embodiment includes a second LED. In a case in which the operation mode is set to the automatic speed-change mode, the second display 14c illuminates (i.e., the second LED illuminates). In a case in which the rotational direction is set to the reverse direction, the first display 14b and the second display 14c blink.

As shown in FIG. 2 and FIG. 4, the manipulation unit 12 includes a second manual switch 16. In the present embodiment, the second manual switch 16 is in the form of a lever. The second manual switch 16 may be also referred to as “lever 16”. The second manual switch 16 is pivotable about a rotational axis 160. More specifically, as shown in FIG. 4, the second manual switch 16 can move (i.e., pivot) between a first position P1 and a fourth position P4 in a first direction D1 and a second direction D2. As shown in FIG. 2 and FIG. 4, the manipulation unit 12 includes a stopper 17. The second manual switch 16 comes into contact with the stopper 17 in response to reaching the fourth position P4.

As shown in FIG. 2, the second manual switch 16 includes a shaft portion 16a and a leading end portion 16b. A first end of the shaft portion 16a is fixed to a lever supporter 20 (see FIG. 5) inside the manipulation unit 12. The leading end portion 16b is provided at a second end of the shaft portion 16a. The rotational axis 160 is a virtual axis in the vicinity of the first end of the shaft portion 16a. The shaft portion 16a extends from the rotational axis 160 in a direction perpendicular to or substantially perpendicular to the rotational axis 160.

The leading end portion 16b is touched by the user when the user moves the second manual switch 16. The user can apply a load to the leading end portion 16b in the first direction D1 or the second direction D2, for example, by the user's thumb, thereby moving the second manual switch 16.

With such a configuration, the leading end portion 16b moves along a movement path Y having an arc-shape (see FIG. 4). The movement path Y is located in an arc of a circle with a radius from the rotational axis 160 to a leading end of the second manual switch 16. The first direction D1 and the second direction D2 are along the arc. A first end of the movement path Y corresponds to the first position P1, and a second end of the movement path Y corresponds to the fourth position P4.

In response to the second manual switch 16 being pressed by the user from the first position P1 in the second direction D2, the second manual switch 16 is moved in the second direction D2. In this case, the second manual switch 16 may reach the fourth position P4, through a second position P2 and a third position P3. In response to the second manual switch 16 being pressed by the user from the fourth position P4 in the first direction D1, the second manual switch 16 is moved in the first direction D1. In this case, the second manual switch 16 may reach the first position P1, through the third position P3 and the second position P2.

Between the second position P2 and the third position P3, a first reference position Pa is located. Between the third position P3 and the fourth position P4, a second reference position Pb is located. FIG. 4 shows a state in which the second manual switch 16 is located in the first reference position Pa.

The second manual switch 16 has a movement range including a first region R1, a second region R2, and a third region R3, a switching occurrence region Ra. The first region R1 defines the entire area between the first position P1 and the second position P2. The second region R2 defines the entire area between the second position P2 and the third position P3. The third region R3 defines the entire area between the third position P3 and the fourth position P4. The switching occurrence region Ra defines the entire area between the first reference position Pa and the second reference position Pb.

When the second manual switch 16 is moved from the first region R1 to the third region R3, the second manual switch 16 passes through the second region R2. When the second manual switch 16 is moved from the third region R3 to the first region R1, the second manual switch 16 passes through the second region R2.

The first reference position Pa and the second reference position Pb are positions that allow the user to have “click feel” from the second manual switch 16. The click feel refers to a specific tactile feedback, a sensation, or a resistance. The user can smoothly move the second manual switch 16, other than the switching occurrence region Ra. Specifically, the user can move the second manual switch 16 outside the switching occurrence region Ra, using a first force. On the other hand, moving the second manual switch 16 within the switching occurrence region Ra requires a second force. The second force is greater than the first force. Moving the second manual switch 16 from an outside of the switching occurrence region Ra into the switching occurrence region Ra requires a third force. The third force is also greater than the first force.

With such a structure, when the second manual switch 16 is moved by the user in the second direction D2 to reach the first reference position Pa, the user has the click feel from the second manual switch 16. In particular, when the second manual switch 16 attempts to be moved into the switching occurrence region Ra across the first reference position Pa, the click feel occurs. The click feel enables the user to identify that the second manual switch 16 reaches the first reference position Pa.

When the second manual switch 16 (i) is moved by the user in the first direction D1 and (ii) to thereby reach the second reference position Pb, the user has the click feel from the second manual switch 16. In particular, when the second manual switch 16 attempts to be moved into the switching occurrence region Ra across the second reference position Pb, the click feel occurs. The click feel enables the user to identify that the second manual switch 16 reaches the second reference position Pb.

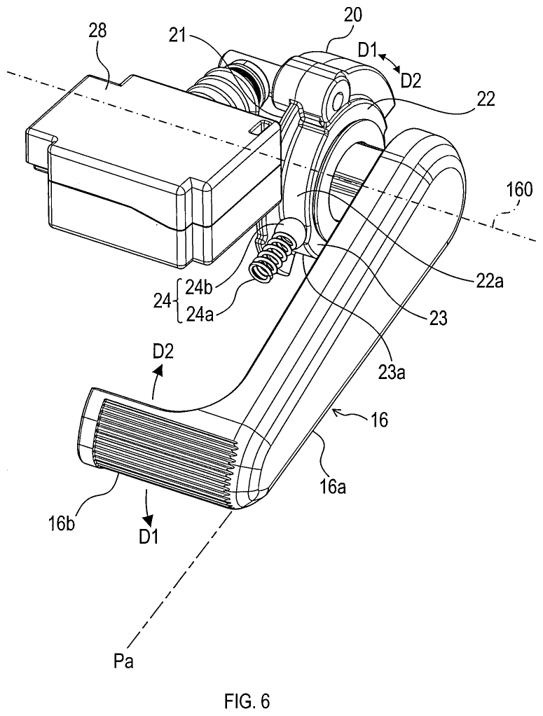

With reference to FIG. 5 and FIG. 6, more specifically, an internal configuration of the manipulation unit 12 and how the click feel occurs will be described. FIG. 5 shows an inside of the manipulation unit 12 when the second manual switch 16 is located in the first reference position Pa. In FIG. 5, an illustration of the second manual switch 16 is omitted. FIG. 6 shows the second manual switch 16 located in the first reference position Pa, and components inside the manipulation unit 12 that are coupled to the second manual switch 16.

As shown in FIG. 5, the manipulation unit 12 includes the above-described the trigger switch 27. The manipulation unit 12 includes a switch box 28. The switch box 28 includes a lever switch 51 and a speed-change signal outputter 52 (see FIG. 7). The lever switch 51 is turned ON or OFF in accordance with a position of the second manual switch 16. The speed-change signal outputter 52 outputs a speed-change signal in accordance with the position of the second manual switch 16.

As shown in FIG. 5 and FIG. 6, the manipulation unit 12 includes the lever supporter 20 and a biasing member 24.

The lever supporter 20 includes a cylindrical body 22 and a flange 21. The flange 21 is provided at a first end of the cylindrical body 22. As described above, the first end of the second manual switch 16 is fixed to the lever supporter 20. Specifically, the first end of the second manual switch 16 is fixed to a second end of the cylindrical body 22. The lever supporter 20 rotates about the rotational axis 160 integrally with the second manual switch 16. Specifically, when the second manual switch 16 is moved (i.e., pivots) in the first direction D1 by the user, the lever supporter 20 also rotates in the first direction D1 (in other words, in a counterclockwise direction in FIG. 5) in accordance with movement of the second manual switch 16. When the second manual switch 16 is moved by the user in the second direction D2, the lever supporter 20 also rotates in the second direction D2 (in other words, in a clockwise direction in FIG. 5) in accordance with movement of the second manual switch 16.

The cylindrical body 22 includes a cylindrical surface 22a and a protrusion 23. The protrusion 23 is provided on the cylindrical surface 22a. The protrusion 23 includes a protrusion surface 23a. A distance from the rotational axis 160 to the protrusion surface 23a is longer than a distance from the rotational axis 160 to the cylindrical surface 22a.

The biasing member 24 includes an elastic member 24a and a distal member 24b. The elastic member 24a may be in any form capable of exerting an elastic force. The elastic member 24a in the present embodiment is in the form of a coil spring. Although details are not illustrated, a first end of the elastic member 24a is fixed inside the manipulation unit 12. The distal member 24b is fixed to a second end of the elastic member 24a. In the present embodiment, the distal member 24b is in a form of metal having a spherical shape.

The distal member 24b is biased toward the cylindrical surface 22a (in other words, toward the rotational axis 160) by the elastic member 24a. Herein, regarding a state of the manipulation unit 12, a protrusion surface contact state and a protrusion surface non-contact state are defined. The protrusion surface contact state is a state in which the distal member 24b climbs onto the protrusion 23 and is in contact with the protrusion surface 23a. The protrusion surface non-contact state is a state in which the distal member 24b is not in contact with the protrusion surface 23a.

In the protrusion surface non-contact state, the distal member 24b is in contact with the cylindrical surface 22a or is slightly away from the cylindrical surface 22a. At this time, a distance from the rotational axis 160 to the distal member 24b is shorter than a distance from the rotational axis 160 to the protrusion surface 23a. FIG. 5 and FIG. 6 show the distal member 24b in the protrusion surface non-contact state. However, in FIG. 5 and FIG. 6, the distal member 24b is in contact with a first side surface of the protrusion 23. That is, when the second manual switch 16 is located in the first reference position Pa, the distal member 24b is in contact with a side surface of the protrusion 23. At this time, the elastic member 24a may or may not contract at all. From this state, when the second manual switch 16 is moved in the second direction D2, the elastic member 24a contracts due to a load received from the protrusion 23 via the distal member 24b. This allows the distal member 24b to climb onto the protrusion 23 and then come into contact with the protrusion surface 23a. That is, the manipulation unit 12 transitions to the protrusion surface contact state. In the protrusion surface contact state, when the second manual switch 16 is further moved in the second direction D2 and reaches the second reference position Pb, the distal member 24b is separated from the protrusion 23 and faces the cylindrical surface 22a. That is, in the present embodiment, when the second manual switch 16 is located within the switching occurrence region Ra, the manipulation unit 12 is in the protrusion surface contact state, and when the second manual switch 16 is outside the switching occurrence region Ra, the manipulation unit 12 is in the protrusion surface non-contact state.

The load that the lever supporter 20 receives from the distal member 24b is greater in the protrusion surface contact state than in the protrusion surface non-contact state. Accordingly, a force required to move the second manual switch 16 within the switching occurrence region Ra is greater than a force required to move the second manual switch 16 outside the switching occurrence region Ra. In other words, when the user moves the second manual switch 16 within the switching occurrence region Ra, the user senses a greater resistance than that when moving the second manual switch 16 outside the switching occurrence region Ra. Such a difference in force (in other words, difference in resistance received via the second manual switch 16) leads to occurrence of the above-described click feel.

The user can manually operate the first manual switch 11 and the second manual switch 16 by the single hand (for example, right hand) simultaneously while gripping the right grip 8 with the same hand. Specifically, for example, the user can move the second manual switch 16 with the thumb while pressing the first manual switch 11 with the index finger.

### (2-1-3) Electrical Configuration

With reference to FIG. 7, an electrical configuration of the electric work machine 1 will be described. The electric work machine 1 includes the motor 60 and the controller 40. On the basis that the battery pack 100 is attached to the battery holder, the battery 100a is electrically coupled to the controller 40 as shown in FIG. 7.

In the present embodiment, the motor 60 is in the form of a brushless motor. The motor 60 includes terminals 60a, 60b, 60c. The terminals 60a, 60b, 60c are electrically coupled to the controller 40 (in particular, a below-described drive circuit 45). The motor 60 includes three windings (not shown) therein. The three windings are coupled to each other in a delta configuration or star configuration. The three windings are electrically coupled to the terminals 60a, 60b, 60c. The motor 60 receives a three-phase power from the controller 40 via the terminals 60a, 60b, 60c, and thereby is rotated.

The controller 40 includes the control circuit 41. The control circuit 41 includes a microcomputer including a CPU 41a and a memory 41b. Examples of the memory 41b include a semiconductor memory, such as a read only memory (ROM), a random access memory (RAM), a non-volatile RAM (NVRAM), and a flash memory. The control circuit 41 (in particular, CPU 41a) implements various functions by executing a program stored in the memory 41b. The control circuit 41 also causes the memory 41b to store temporary data generated in accordance with various functions.

A part or all of the various functions implemented by the control circuit 41 may be achieved by program execution (i.e., by software processing) or by one or more hardware components. For example, the control circuit 41 may include a logic circuit including two or more electronic components, instead of or in addition to a microcomputer. Also, the control circuit 41 may include, for example, an application specific IC such as an application specified integrated circuit (ASIC) and/or an application-specific standard product (ASSP), or a programmable logic device such as a field programmable gate array (FPGA), allowing configuring any logic circuit.

The controller 40 includes a power-supply control circuit 42 and a regulator 43. The power-supply control circuit 42 is electrically coupled to a positive electrode of the battery 100a to receive a direct-current (DC) battery power from the battery 100a. The power-supply control circuit 42 controls a supply of battery power to the regulator 43. Upon receipt of the battery power from the power-supply control circuit 42, the regulator 43 generates a control voltage from the battery power. The control voltage is in the form of a DC voltage. The regulator 43 supplies the control voltage to each component within the controller 40.

At the time point of attaching the battery pack 100 to the battery holder, the main power state of the controller 40 (in other words, the main power state of the control circuit 41) is OFF. That is, at this time point, the control voltage is not supplied to the control circuit 41, and the control circuit 41 is not activated.

The control circuit 41 is electrically coupled to the main power switch 14a. When the main power switch 14a is pressed after the battery pack 100 is attached to the battery holder, the main power signal is input from the main power switch 14a to the power-supply control circuit 42 and the control circuit 41. In response to receiving the main power signal, the power-supply control circuit 42 supplies the battery power to the regulator 43. Accordingly, the control voltage is supplied from the regulator 43 to the control circuit 41, and the control circuit 41 is activated.

When activated, the control circuit 41 (i) sets the main power state to ON and (ii) continuously output a power retaining signal to the power-supply control circuit 42. While the power-supply control circuit 42 is receiving the power retaining signal, a battery voltage is supplied to the regulator 43.

When the main power state is ON and the long pressed is performed on the main power switch 14a, the control circuit 41 (i) performs a necessary process to stop the own operation, and subsequently (ii) sets the main power state to OFF. When setting the main power state to OFF, the control circuit 41 stops the power retaining signal. Each time the short press is performed on the main power switch 14a when the main power state is ON, the control circuit 41 alternately switches the rotational direction.

When the input of the power retaining signal to the power-supply control circuit 42 is stopped, the power-supply control circuit 42 stops supplying the battery power to the regulator 43. Accordingly, the control voltage is not generated by the regulator 43, and an operation of the control circuit 41 is stopped. The definitions of “ON” and “OFF” for the main power state may be defined in any way as desired. For example, the “ON” of the main power state may be defined as a state in which the control voltage is supplied to the control circuit 41 and the control circuit 41 is activated. For example, the “OFF” of the main power state may be defined as a state in which the control voltage is not supplied to the control circuit 41 and the operation of the control circuit 41 is stopped.

The controller 40 includes a gate circuit 44 and a drive circuit 45. The gate circuit 44 is electrically coupled to the positive electrode of the battery 100a and receives the battery power. The drive circuit 45 is electrically coupled to the positive electrode of the battery 100a via an interruption switch 49 and receives the battery power via the interruption switch 49.

The drive circuit 45 in the present embodiment is in the form of a three-phase full-bridge circuit. Specifically, the drive circuit 45 includes three high-side switching devices and three low-side switching devices. Each switching device and the interruption switch 49 are in the form of, for example, a semiconductor switching element, more specifically, in the form of, for example, a metal oxide semiconductor field effect transistor (MOSFET).

The control circuit 41 outputs a first switch control signal and motor control signals to the gate circuit 44. The first switch control signal controls the interruption switch 49. The motor control signals control the drive circuit 45, thereby controlling the rotation of the motor 60. The motor control signals include six second switch control signals, each of which corresponds to one of the six switching devices located in the drive circuit 45. In the present embodiment, the six second switch control signals may be in the form of, for example, pulse-width modulation signals (PWM signals).

The gate circuit 44 outputs, to the interruption switch 49, a first switch drive signal based on the first switch control signal. In a case in which the first switch control signal indicates that ON of the interruption switch 49, the gate circuit 44 outputs, to the interruption switch 49, the first switch drive signal for turning ON the interruption switch 49. This causes the interruption switch 49 to be turned ON, electrically coupling the drive circuit 45 to the battery 100a via the interruption switch 49. The gate circuit 44 outputs, to the drive circuit 45, motor drive signals based on the motor control signals. The motor drive signals include six second switch drive signals. Each second switch drive signal outputs to the corresponding one of the six switching devices. The six switching devices are turned ON or OFF in accordance with the corresponding second switch drive signals. The gate circuit 44 generates the first switch drive signals and the motor drive signals from the battery power.

When the motor 60 is being driven, the control circuit 41 turns ON the interruption switch 49 via the gate circuit 44 and drives the drive circuit 45 by the first switch control signal and the motor control signals. This causes the motor 60 to be driven.

The drive circuit 45 operates in accordance with the motor control signals from the control circuit 41 (in particular, in accordance with the motor drive signals from the gate circuit 44). In a case in which the motor control signals for driving the motor 60 are output, the drive circuit 45 generates a three-phase power in accordance with the corresponding motor control signals and supplies the three-phase power to the motor 60.

The controller 40 includes a battery voltage detector 53. The battery voltage detector 53 (i) detects a battery voltage value, and (ii) outputs, to the control circuit 41, a voltage signal indicating the battery voltage value that has been detected. The battery voltage value corresponds to a magnitude of the output voltage of the battery pack 100.

The controller 40 includes a current detection circuit 46. The current detection circuit 46 (i) detects a battery current value, and (ii) outputs, to the control circuit 41, a current signal indicating the battery current value that has been detected. The battery current value corresponds to a magnitude of the electric current supplied from the battery pack 100 to the drive circuit 45 (thus, to the motor 60).

The controller 40 includes a temperature detection circuit 47. The temperature detection circuit 47 (i) detects a circuit temperature of the controller 40, and (ii) outputs, to the control circuit 41, a temperature signal indicating the circuit temperature that has been detected.

The controller 40 includes a position detection circuit 48. The position detection circuit 48 is electrically coupled to the terminals 60a, 60b, 60c of the motor 60. The position detection circuit 48 receives first through third induced voltages from the terminals 60a, 60b, 60c. The first induced voltage is an induced voltage generated between the terminals 60a, 60b in accordance with the rotation of the motor 60. The second induced voltage is an induced voltage generated between the terminals 60b, 60c. The third induced voltage is an induced voltage generated between the terminals 60c, 60a.

The position detection circuit 48 outputs, to the control circuit 41, position detection signals based on the first through third induced voltages. Each position detection signal indicates a rotational position of the motor 60. Specifically, the position detection circuit 48 detects (i) a time point (first zero-cross point) at which the first induced voltage crosses a reference voltage value in a process of transition, (ii) a time point (second zero-cross point) at which the second induced voltage crosses a reference voltage value in a process of transition, and (iii) a time point (third zero-cross point) at which a third induced voltage crosses a reference voltage value in a process of transition. The position detection circuit 48 outputs, to the control circuit 41, the position detection signals indicating the first through third zero-cross points that have been detected.

The control circuit 41 detects a rotational position and a rotational speed of the motor 60, based on the position detection signal (i.e., based on the first through third zero-cross points). It is noted that a method of detecting the rotational position and the rotational speed based on the first through third induced voltages is known well as a core technique for a sensorless drive of a brushless motor.

The control circuit 41 rotates the motor 60 in the forward direction, based on (i) the rotational direction being set to the forward direction and (ii) a drive requirement being satisfied. When the motor 60 rotates in the forward direction, the cutting blade 5 rotates in a cutting direction. The cutting direction is a rotational direction that allows the cutting object to be cut.

On the other hand, when (i) the rotational direction is set to the reverse direction and (ii) the first manual switch 11 is turned ON, the control circuit 41 rotates the motor 60 in the reverse direction for a specified period of time. When the motor 60 rotates in the reverse direction, the cutting blade 5 rotates in an untangle direction. The untangle direction is opposite to the cutting direction. Rotation of the cutting blade 5 in the untangle direction enables the cutting object tangled around the cutting blade 5 during rotation in the cutting direction to be removed from the cutting blade 5. After rotating the motor 60 in the reverse direction for the specified period of time, the control circuit 41 sets the rotational direction to the forward direction.

The control circuit 41 is electrically coupled to the trigger switch 27. While the trigger switch 27 is ON, a first signal is input from the trigger switch 27 to the control circuit 41. The first signal indicates that the trigger switch 27 is ON (and thus, the first manual switch 11 is ON, more specifically, the first manual switch 11 is moved a distance greater than or equal to a specific distance from the first initial position).

The control circuit 41 is electrically coupled to the lever switch 51 and the speed-change signal outputter 52.

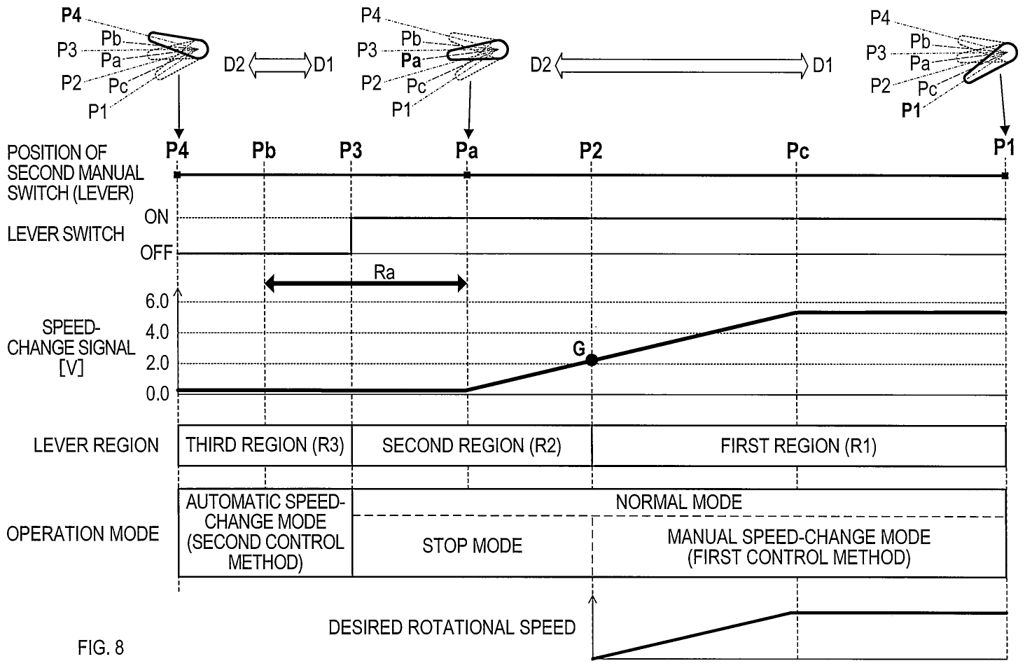

While the lever switch 51 is ON, a second signal is input from the lever switch 51 to the control circuit 41. As shown in FIG. 8, when the second manual switch 16 is located within the third region R3, the lever switch 51 is turned OFF, and when the second manual switch 16 is located within the first region R1 or the second region R2, the lever switch 51 is turned ON. The second signal indicates that the lever switch 51 is ON (and thus, the second manual switch 16 is located within the first region R1 or the second region R2).

The speed-change signal has a voltage in accordance with the position of the second manual switch 16. As shown in FIG. 8, when the second manual switch 16 is located between the first reference position Pa and the fourth position P4, the speed-change signal has a substantially constant voltage value approximately to 0[V]. If the second manual switch 16 is moved from the first reference position Pa in the first direction D1, a voltage value of the speed-change signal (hereinafter, referred to as “speed-change signal value”) gradually increases in accordance with such a movement. Specifically, the speed-change signal value increases as a distance from the first reference position Pa increases.

In the present embodiment, when the second manual switch 16 reaches a highest speed achievement position Pc, an increase in the speed-change signal value is stopped. If the second manual switch 16 is further moved from the highest speed achievement position Pc in the first direction D1, the speed-change signal value does not change. The highest speed achievement position Pc may be set to any position within the first region R1 (other than the second position P2). Alternatively, the highest speed achievement position Pc does not have to be set. In other words, the highest speed achievement position Pc may be consistent with the first position P1. In this case, the speed-change signal value gradually increases until the second manual switch 16 is moved from the second position P2 to the first position P1.

In the present embodiment, the speed-change signal value linearly increases. However, the speed-change signal value may increase in any manner. For example, the speed-change signal value may increase in a non-linear manner. More specifically, the speed-change signal value may be, for example, in a stepwise manner.

The control circuit 41 is electrically coupled to the first display 14b and the second display 14c. The control circuit 41 individually controls, the first display 14b and the second display 14c. Specifically, as described above, the control circuit 41 individually illuminates, blinks, or turns off the first LED and the second LED in accordance with the state of the electric work machine 1.

### (2-1-4) Operation Mode

With reference to FIG. 8, the operation mode will be specifically described. The operation mode is set by the control circuit 41. In the present embodiment, in a case in which the rotational direction that has been set is the forward direction, the operation mode is set. Specifically, as shown in FIG. 8, the operation mode is set in accordance with the position of the second manual switch 16. The operation mode indicates the operation mode of the control circuit 41 (and thus, the operation mode of the controller 40 or the operation mode of the electric work machine 1).

When the second manual switch 16 is located within the first region R1 or the second region R2, the control circuit 41 sets the operation mode to the normal mode. When the second manual switch 16 is located within the third region R3, the control circuit 41 sets the operation mode to the automatic speed-change mode.

As described above, the normal mode includes the stop mode and the manual speed-change mode. The control circuit 41 sets the operation mode to (i) the manual speed-change mode when the second manual switch 16 is located within the first region R1, and (ii) the stop mode when the second manual switch 16 is located within the second region R2.

In the present embodiment, the control circuit 41 determines whether the second manual switch 16 has been moved to the first region R1 (or is located within the first region R1), based on the speed-change signal value. In a case in which the speed-change signal value is less than a signal threshold, the control circuit 41 determines that the second manual switch 16 is not located within the first region R1. The signal threshold is a speed-change signal value at an operation point G shown in FIG. 8. The operation point G corresponds to a boundary of the first region R1 and the second region R2. In a case in which the speed-change signal value is greater than or equal to the signal threshold, the control circuit 41 determines that the second manual switch 16 is located within the first region R1, thereby setting the operation mode to the manual speed-change mode.

In a case in which the lever switch 51 is ON and the speed-change signal value is less than the signal threshold, the control circuit 41 determines that the second manual switch 16 is located within the second region R2, thereby setting the operation mode to the stop mode.

In a case in which the lever switch 51 is OFF, the control circuit 41 determines that the second manual switch 16 is located within the third region R3, thereby setting the operation mode to the automatic speed-change mode.

The control circuit 41 rotates the motor 60 using the first switch control signal and the motor control signals, on the basis that the drive requirement is satisfied. In the present embodiment, the drive requirement is satisfied on the basis that (i) the rotational direction is set to the forward direction, (ii) the trigger switch 27 is ON, and (iii) the second manual switch 16 is located within the first region R1 or the third region R3 (or, the operation mode is set to the manual speed-change mode or the automatic speed-change mode).

In a case in which the drive requirement is satisfied and the operation mode is set to the manual speed-change mode (that is, the second manual switch 16 is located within the first region R1), the control circuit 41 rotates the motor 60 in accordance with a first control system. In other words, the control circuit 41 controls the drive circuit 45 using the first switch control signal and the motor control signals so that the motor 60 rotates in accordance with the first control system. The first control system is a control system corresponding to the manual speed-change mode.

In the first control system, the motor 60 is controlled to rotate at a desired rotational speed in accordance with the position of the second manual switch 16. Specifically, in the first control system, the control circuit 41 sets the desired rotational speed based on the position of the second manual switch 16 (specifically, based on the speed-change signal value). FIG. 8 shows an example of setting the desired rotational speed in the first control system. As shown in FIG. 8, in the present embodiment, the desired rotational speed increases as the second manual switch 16 is moved from the second position P2 to the highest speed achievement position Pc. The desired rotational speed has a maximum value when the second manual switch 16 reaches the highest speed achievement position Pc. In the present embodiment, if the second manual switch 16 is further moved from the highest speed achievement position Pc in the first direction D1, the desired rotational speed maintains at the maximum value. The desired rotational speed when the second manual switch 16 is located within the second position P2 (i.e., smallest value of the desired rotational speed) may be zero or greater than zero.

In accordance with the movement of the second manual switch 16 from the second position P2 to the first position P1, the desired rotational speed may increase. The desired rotational speed may increase in any manner. The desired rotational speed may increase, for example, linearly or non-linearly. The desired rotational speed may increase non-continuously (for example, in a stepwise manner). A section where the desired rotational speed continuously increases and a section where the desired rotational speed non-continuously increase may coexist.

The control circuit 41 detects a rotational speed (i.e., actual rotational speed) of the motor 60 based on the position detection signal from the position detection circuit 48. The control circuit 41 compares the rotational speed that has been detected with the desired rotational speed that has been set. The control circuit 41 generates and outputs the motor control signals such that the actual rotational speed is consistent with the desired rotational speed.

In the stop mode, regardless of the state of the trigger switch 27, the control circuit 41 stops the motor 60. That is, even if the trigger switch 27 is ON, the control circuit 41 stops the motor 60 in the stop mode. In a case in which the trigger switch 27 is OFF, the control circuit 41 stops the motor 60, regardless of the position of the second manual switch 16.

In a case in which the drive requirement is satisfied and the operation mode is set to the automatic speed-change mode (that is, the second manual switch 16 is located within the third region R3), the control circuit 41 rotates the motor 60 in accordance with a second control system. In other words, the control circuit 41 controls the drive circuit 45 using the above-described first switch control signal and motor control signals so that the motor 60 rotates in accordance with the second control system. The second control system is a control system corresponding to the automatic speed-change mode and is different from the first control system.

In the second control system, the motor 60 is controlled to rotate at the desired rotational speed corresponding to a magnitude of a load being applied to the motor 60. Specifically, in the second control system, the control circuit 41 detects the magnitude of the load being applied to the motor 60. Herein, the load is, for example, a force applied to a rotor of the motor 60 in a direction opposite to the rotational direction of the motor 60. The load applied to the motor 60 may vary depending on conditions of the cutting operation using the cutting blade 5. In a state in which the cutting operation is not performed and the cutting blade 5 rotates idly, the load is the smallest. When the cutting blade 5 comes into contact with the cutting object to perform the cutting operation, the load increases. The magnitude of the load may be detected in any manner. The magnitude of the load may be detected, for example, based on the battery current value indicated by the current signal.

In the second control system, the control circuit 41 sets the desired rotational speed in accordance with the magnitude of the load. Specifically, in the present embodiment, the desired rotational speed increases with an increase in the load. The control circuit 41 may set the desired rotational speed in any manner in accordance with the magnitude of the load. For example, in a case in which the magnitude of the load is less than a load threshold, the control circuit 41 may set the desired rotational speed to a first speed, and in a case in which the magnitude of the load is greater than or equal to the load threshold, the control circuit 41 may set the desired rotational speed to a second speed. The second speed is greater than the first speed. In a case in which the cutting blade 5 rotates idly, the desired rotational speed that is smaller than the first speed may be set. The desired rotational speed may vary continuously or in a stepwise manner, depending on the magnitude of the load.

The electric work machine 1 in the embodiment further includes the following feature. Specifically, the control circuit 41 stops the motor 60 on the basis that (i) the motor 60 is driven in the manual speed-change mode, (ii) the trigger switch 27 remains ON, and (iii) the second manual switch 16 has been moved from the first region R1 to the third region R3 (that is, switched the operation mode to the automatic speed-change mode). This feature corresponds to an example of the first stop operation described in the Overview of Embodiment.

In a case in which the second manual switch 16 is moved from the first region R1 in the second direction D2, the second manual switch 16 is moved to the second region R2 earlier than the third region R3. Accordingly, the control circuit 41 stops the motor 60 at a time point when the second manual switch 16 enters the second region R2. Thereafter, in a case in which the trigger switch 27 is not OFF and the second manual switch 16 is further moved to the third region R3, the control circuit 41 keeps the motor 60 stopped. Further, in a case in which is a re-trigger is performed by the user, the control circuit 41 rotates the motor 60 in the automatic speed-change mode (i.e., in accordance with the second control system). The “re-trigger” indicates that the first manual switch 11 is operated to turn OFF the trigger switch 27 once, and then turn ON the trigger switch 27 again.

Similarly, the control circuit 41 stops the motor 60 on the basis that (i) the motor 60 is driven in the automatic speed-change mode, (ii) the trigger switch 27 remains ON, and (iii) the second manual switch 16 has been moved from the third region R3 to the first region R1 (that is, switched from the operation mode to the manual speed-change mode). This feature corresponds to an example of the second stop operation described in the Overview of Embodiment. In a case in which the second manual switch 16 is moved from the third region R3 in the first direction D1, the second manual switch 16 is moved to the second region R2 earlier than the first region R1. Accordingly, the control circuit 41 stops the motor 60 at a time point when the second manual switch 16 enters the second region R2. Thereafter, in a case in which the trigger switch 27 is not OFF and the second manual switch 16 is further moved to the first region R1, the control circuit 41 keeps the motor 60 stopped. Further, in response to the re-trigger having been performed, the control circuit 41 rotates the motor 60 in the manual speed-change mode (i.e., in accordance with the first control system).

### (2-1-5) Process Executed by Control Circuit

The following describes a main power state setting process, a mode switching detection process, an operation mode setting process, and a motor control process, which are executed by the control circuit 41 (in particular, CPU 41a). The various operations described above are achieved through these processes executed by the control circuit 41. In the present embodiment, programs for these processes are stored in, for example, the memory 41b. The control circuit 41 achieves these processes by executing the corresponding programs.

### (2-1-5-1) Main Power State Setting Process

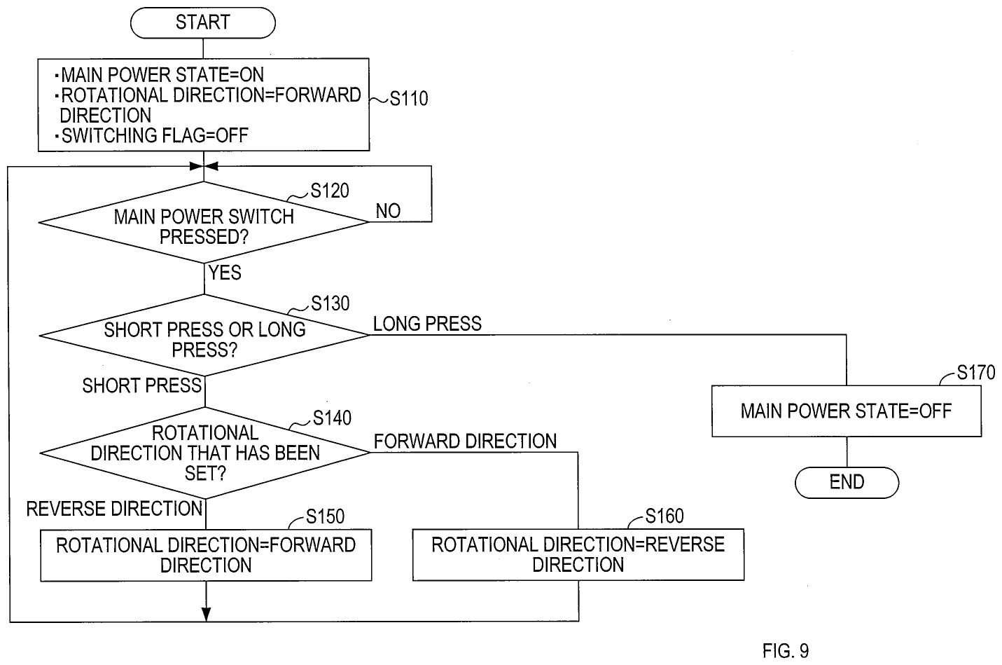

With reference to FIG. 9, the main power state setting process will be described. In the main power state setting process, the main power state and the rotational direction are set. The control circuit 41 is activated upon receipt of the control voltage and then executes the main power state setting process.

The control circuit 41 starts the main power state setting process. In S110, the control circuit 41 (i) sets the main power state to ON, (ii) sets the rotational direction to the forward direction, and (iii) sets a switching flag to OFF.

In S120, the control circuit 41 determines whether the main power switch 14a is pressed. Based on receipt of the main power signal, the control circuit 41 can determine that the main power switch 14a is pressed. If the main power switch 14a is not pressed, the control circuit 41 repeats the process of S120. If the main power switch 14a is pressed, the present process proceeds to S130.

In S130, the control circuit 41 determines whether a short press or a long press is performed on the main power switch 14a. If the short press is performed on the main power switch 14a, the present process proceeds to S140. In S140, the control circuit 41 determines the rotational direction that has been set. If the rotational direction that has been set is the forward direction, the present process proceeds to S160. In S160, the control circuit 41 sets the rotational direction to the reverse direction, and then the process proceeds to S120. In S140, if the rotational direction that has been set is the reverse direction, the present process proceeds to S150. In S150, the control circuit 41 sets the rotational direction to the forward direction, and then proceeds to S120.

In S130, if it is determined that the long press is performed on the main power switch 14a, the present process proceeds to S170. In S170, the control circuit 41 sets the main power state to OFF, and then the present process is completed. In S170, the control circuit 41 stops an output of the power retaining signal to the power-supply control circuit 42. Accordingly, a supply of the control voltage to the control circuit 41 is stopped, and then the control circuit 41 stops operating.

### (2-1-5-2) Mode Switching Detection Process

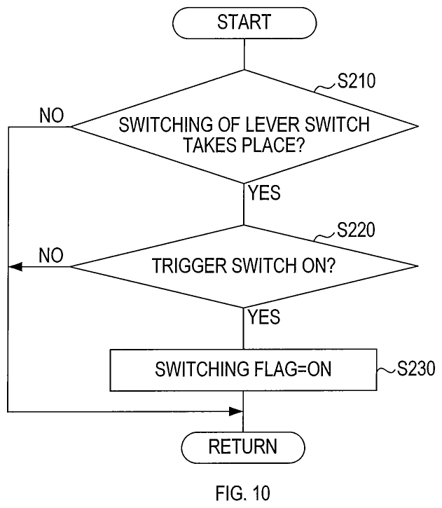

With reference to FIG. 10, the mode switching detection process will be described. In the mode switching detection process, it is detected that the operation mode has been switched from the automatic speed-change mode to the normal mode (or, from the normal mode to the automatic speed-change mode). When activated, the control circuit 41 repeatedly executes the mode switching detection process in a specific control cycle.

The control circuit 41 starts the mode switching detection process. In S210, the control circuit 41 determines whether switching of the lever switch 51 takes place. The switching of the lever switch 51 indicates that the lever switch 51 is switched from ON to OFF, or the lever switch 51 is switched from OFF to ON. If the switching of the lever switch 51 does not take place, the control circuit 41 completes the present process. If the switching of the lever switch 51 takes place, the present process proceeds to S220.

In S220, the control circuit 41 determines whether the trigger switch 27 is ON. If the trigger switch 27 is OFF, the control circuit 41 completes the present process. If the trigger switch 27 is ON, the present process proceeds to S230.

In S230, the control circuit 41 sets the switching flag to ON. After the process of S230, the control circuit 41 completes the present process.

### (2-1-5-3) Operation Mode Setting Process

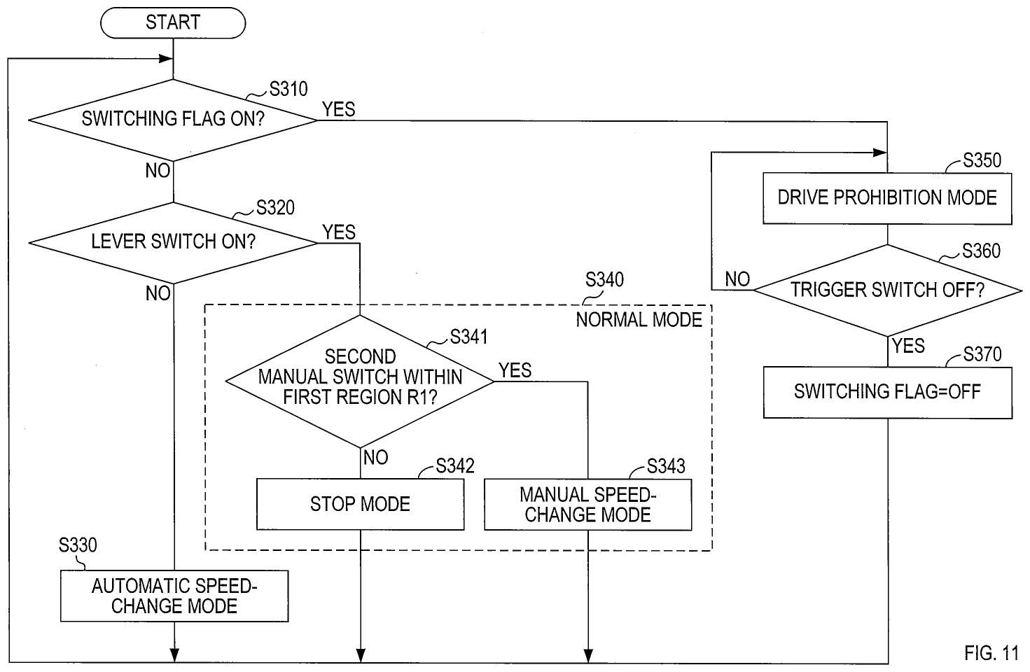

With reference to FIG. 11, the operation mode setting process will be described. In the operation mode setting process, the operation mode is set. If the rotational direction that has been set is the forward direction, the control circuit 41 repeatedly executes the operation mode setting process in, for example, the above-described control cycle.

The control circuit 41 starts the operation mode setting process. In S310, the control circuit 41 determines whether the switching flag is set to ON. If the switching flag is set to OFF, the present process proceeds to S320.

In S320, the control circuit 41 determines whether the lever switch 51 is ON. If the lever switch 51 is OFF (that is, if the second manual switch 16 is located within the third region R3), the present process proceeds to S330. In S330, the control circuit 41 sets the operation mode to the automatic speed-change mode, and then proceeds to S310. If the lever switch 51 is ON (that is, if the second manual switch 16 is located within the first region R1 or the second region R2), the present process proceeds to S340.

In S340, the control circuit 41 sets the operation mode to the normal mode. More specifically, in S341, the control circuit 41 determines whether the second manual switch 16 is located within the first region R1. If the second manual switch 16 is not located within the first region R1 (that is, within the second region R2), the present process proceeds to S342. In S342, the control circuit 41 sets the operation mode to the stop mode, and the process proceeds to S310. In S341, if the second manual switch 16 is located within the first region R1, the present process proceeds to S343. In S343, the control circuit 41 sets the operation mode to the manual speed-change mode, and the process proceeds to S310.

In S310, if the switching flag is set to ON, the present process proceeds to S350. In S350, the control circuit 41 sets the operation mode to the drive prohibition mode. In S360, the control circuit 41 determines whether the trigger switch 27 is OFF. If the trigger switch 27 is ON, the present process proceeds to S350. That is, after the operation mode is set to the drive prohibition mode, the operation mode is kept the drive prohibition mode while the trigger switch 27 is ON. If the trigger switch 27 is OFF, the present process proceeds to S370. In S370, the control circuit 41 sets the switching flag to OFF, and then proceeds to S310.

### (2-1-5-4) Motor Control Process

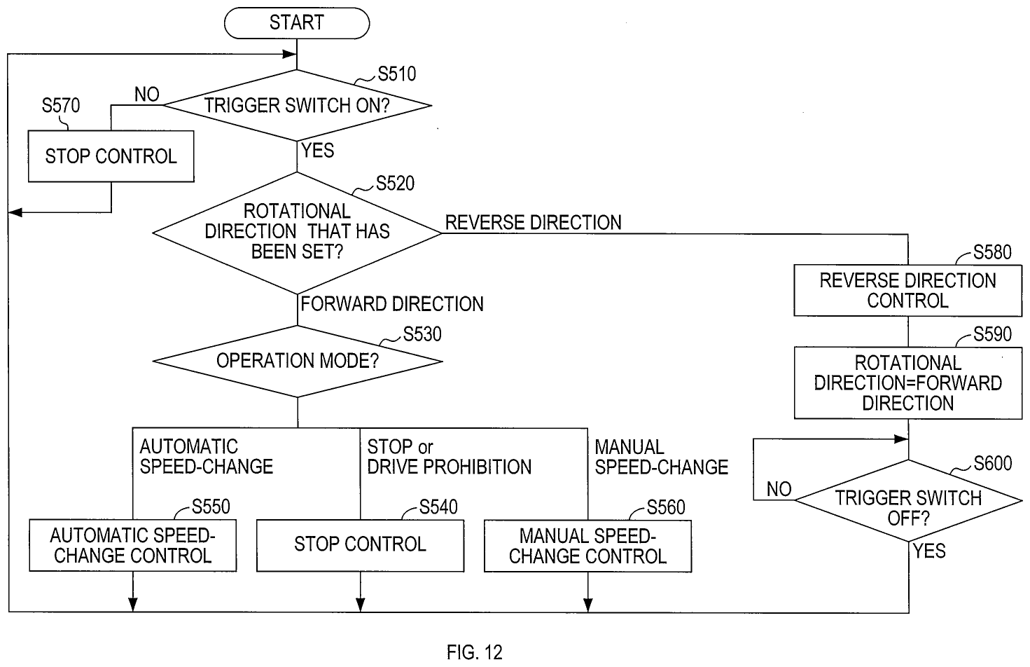

With reference to FIG. 12, the motor control process will be described. In the motor control process, the rotation of the motor 60 is controlled based on the rotational direction and the operation mode. When activated, the control circuit 41 executes the motor control process.

The control circuit 41 starts the motor control process. In S510, the control circuit 41 determines whether the trigger switch 27 is ON. If the trigger switch 27 is OFF, the control circuit 41 executes a stop control in S570, and the process proceeds to S510.

The stop control is a process to stop the rotation of the motor 60. The stop control may be any control that can stop the rotation of the motor 60. The stop control may include, for example, “free running” of the motor 60. The “free running” indicates that a power supply from the battery 100a to the motor 60 is stopped and the six switching devices are turned OFF in the drive circuit 45, thereby letting the motor 60 to rotate by inertia. The stop control may include, for example, forcedly decelerating the motor 60 by braking. The braking may be achieved, for example, by short-circuiting any two or three of the terminals 60a, 60b, 60c of the motor 60. Specifically, for example, the three high-side switching devices in the drive circuit 45 may be turned OFF, and two or more of the three low-side switching devices may be turned ON. This allows the motor 60 to be braked. Such braking is also referred to as a “dynamic braking” or the like. The stop control may include free running and braking. For example, the motor 60 may be stopped in a manner such that the free running is initially performed for a specified period of time and then the braking is performed.

In S570, the stop control may be executed, if the control circuit 41 drives the motor 60 in a transition phase to S570. If the motor 60 is already stopped in the transition phase to S570, the control circuit 41 may maintain the stop state of the motor 60.

In S510, if the trigger switch 27 is ON, the present process proceeds to S520. In S520, the control circuit 41 determines the rotational direction that has been set. If the rotational direction that has been set is the reverse direction, the present process proceeds to S580.

In S580, the control circuit 41 executes a reverse direction control. Specifically, the control circuit 41 rotates the motor 60 in the reverse direction for a specified period of time. After executing the reverse direction control, the control circuit 41 sets the rotational direction to the forward direction in S590. The control circuit 41 waits for the trigger switch 27 to be turned OFF in S600. If the trigger switch 27 is turned OFF, the present process proceeds to S510.

If the rotational direction has been set to the forward direction in S520, the present process proceeds to S530. In S530, the control circuit 41 determines the operation mode that is set at the present time.

If the operation mode is set to the automatic speed-change mode, the present process proceeds to S550. In S550, the control circuit 41 executes an automatic speed-change control. Specifically, the control circuit 41 rotates the motor 60 in accordance with the above-described second control system. After executing the process of S550, the present process proceeds to S510.

If the operation mode is set to the manual speed-change mode, the present process proceeds to S560. In S560, the control circuit 41 executes a manual speed-change control. Specifically, the control circuit 41 rotates the motor 60 in accordance with the above-described first control system. After executing the process of S560, the present process proceeds to S510.

If the operation mode is set to the stop mode or the drive prohibition mode, the present process proceeds to S540. In S540, the control circuit 41 executes the stop control. Specifically, the control circuit 41 stops the rotation of the motor 60. The stop control in S540 may be any control that can stop the rotation of the motor 60. The stop control in S540 may be, for example, the same as the stop control in S570. The stop control in S540 is executed if the control circuit 41 drives the motor 60 in a transition phase to S540. If the motor 60 is already stopped in a transition phase to S540, the control circuit 41 maintains the stop state of the motor 60. After executing the process of S540, the present process proceeds to S510.

### (2-1-6) Correspondence Between Terms

The re-trigger is an example of a specific operation described in the Overview of Embodiment. A combination of the lever supporter 20 with the biasing member 24 is an example of the click feel generator described in the Overview of Embodiment.

### 2-2. Other Embodiments

The embodiment of the present disclosure has been described so far; however, the present disclosure can be carried out in variously modified modes without being limited to the above-described embodiment.

(2-2-1) The first region R1 (manual speed-change mode), the second region R2 (stop mode), and the third region R3 (automatic speed-change mode) may be set to any location in the movement path Y.

In the present embodiment, the first region R1, the second region R2, and the third region R3 are aligned in order along the second direction D2. However, for example, the first region R1, the second region R2, and the third region R3 may be aligned in order along the first direction D1. That is, the operation mode may be switched to the automatic speed-change mode by movement of the second manual switch 16 from the second region R2 in the first direction D1, and the operation mode may be switched to the manual speed-change mode by movement of the second manual switch 16 from the second region R2 in the second direction D2.

Further, for example, the first region R1 and the third region R3 may be adjacent to each other. That is, without passing through the second region R2, the second manual switch 16 may be moved from the first region R1 to the third region R3, and from the third region R3 to the first region R1. Also in this case, in a case in which the second manual switch 16 has been moved from the first region R1 to the third region R3 (alternatively, in the reverse direction) while the trigger switch 27 is ON, the motor 60 may be stopped once. Thereafter, in a case in which the re-trigger is performed, the motor may be rotated in accordance with the control system corresponding to the operation mode (the automatic speed-change mode or the manual speed-change mode) defined by the region where the second manual switch has been moved.

(2-2-2) In the above-described embodiment, when the second manual switch 16 reaches the first reference position Pa and the second reference position Pb, the click feel occurs. However, the click feel may occur in any location. For example, (i) when the second manual switch 16 is moved in the second direction D2 and reaches the third position P3, (ii) when the second manual switch 16 is moved in the first direction D1 and reaches the third position P3, (iii) when the second manual switch 16 is moved in the second direction D2 and reaches the second position P2, and/or (iv) when the second manual switch 16 is moved in the first direction D1 and reaches the second position P2, the click feel may occur. Alternatively, the click feel may occur in a position that is different from the second position P2, the third position P3, the first reference position Pa, and the second reference position Pb. A mechanism for generating the click feel may be provided to allow the user to identify that (i) the second manual switch 16 has been (or is being) moved from the third region R3 to the second region R2, (ii) the second manual switch 16 has been (or is being) moved from the second region R2 to the first region R1, (iii) the second manual switch 16 has been (or is being) moved from the first region R1 to the second region R2, and/or (iv) the second manual switch 16 has been (or is being) moved from the second region R2 to the third region R3.

(2-2-3) The first control system and the second control system may each differ from the methods described in the above-described embodiment. In other words, the electric work machine 1 may include an operation mode different from the automatic speed-change mode, and/or may include an operation mode different from the manual speed-change mode.

(2-2-4) In the automatic speed-change mode, the desired rotational speed may be set in any manner in accordance with the load. For example, contrary to the above-described embodiments, the desired rotational speed may decrease as the load increases. Specifically, for example, in a case in which the magnitude of the load is less than the load threshold, the desired rotational speed is set to the second speed, and in a case in which the magnitude of the load is greater than or equal to the load threshold, the desired rotational speed may be set to the first speed. The first speed is smaller than the second speed.

(2-2-5) The second manual switch 16 and the first manual switch 11 may be provided to the left grip 9 or in the vicinity of the left grip 9. Alternatively, each of the second manual switch 16 and the first manual switch 11 may be provided to a corresponding one of grips.

(2-2-6) The second manual switch 16 may be provided in any form. The movement path Y of the second manual switch 16 may be set in any manner. The second manual switch 16 may be in a form different from a lever. The second manual switch 16 may be in the form of, for example, a sliding witch, a dial, and the like.

The second manual switch of the present disclosure may be provided in any form and any location in the manipulation unit 12. The second manual switch may be provided, for example, on a surface where the operation panel 13 is located. The second manual switch may be moved in any direction, any manner and/or any area.

(2-2-7) The motor 60 may be provided outside the control unit 3. The motor 60 may be accommodated in, for example, the drive unit 4.

(2-2-8) Two or more functions of a single element in the above-described embodiments may be performed by two or more elements, and a single function of a single element may be performed by two or more elements. Two or more functions performed by two or more elements may be performed by a single element, and a single function performed by two or more elements may be performed by a single element. Part of the configuration in the above-described embodiments may be omitted. At least a part of the configuration in the above-described embodiments may be added to or replace another configuration in the above-described embodiments.

What is claimed is:

1. An electric work machine, comprising:
a motor;
a first manual switch configured to be manually operated by a user of the electric work machine;
a second manual switch configured (i) to be manually operated by the user and (ii) to thereby be moved within a movement range, the movement range including a first region, a second region, and a third region; and
a control circuit configured to:
rotate the motor in accordance with a first control system, based on (i) the first manual switch being manually operated and (ii) the second manual switch being within the first region,
stop the motor, based on (i) the first manual switch not being manually operated and/or (ii) the second manual switch being within the second region, and
rotate the motor in accordance with a second control system, based on (i) the first manual switch being manually operated and (ii) the second manual switch being within the third region, the second control system being different from the first control system.

2. The electric work machine according to claim 1, wherein
the second manual switch is configured (i) to be moved from the first region to the third region through the second region and/or (ii) to be moved from the third region to the first region through the second region.

3. The electric work machine according to claim 1, wherein
the control circuit is configured to execute a first stop operation to stop the motor, based on (i) the first manual switch being manually operated and (ii) the second manual switch having been moved from the first region to the third region.

4. The electric work machine according to claim 3, wherein
the control circuit is configured to rotate the motor in accordance with the second control system, based on (i) the first stop operation being performed, (ii) subsequently a manual operation of the first manual switch being released, and (iii) further subsequently the first manual switch having been manually operated.

5. The electric work machine according to claim 1, wherein
the control circuit is configured to execute a second stop operation to stop the motor, based on (i) the first manual switch being manually operated and (ii) the second manual switch having been moved from the third region to the first region.

6. The electric work machine according to claim 5, wherein
the control circuit is configured to rotate the motor in accordance with the first control system, based on (i) the second stop operation being performed, (ii) subsequently a manual operation of the first manual switch being released, and (ii) further subsequently the first manual switch having been manually operated.

7. The electric work machine according to claim 1, wherein
the first control system includes:
setting a desired rotational speed in accordance with a position of the second manual switch within the first region; and
rotating the motor at the desired rotational speed that has been set.

8. The electric work machine according to claim 2, wherein
the first control system includes:
increasing a desired rotational speed with an increase in a distance between the second manual switch and the second region; and
rotating the motor at the desired rotational speed.

9. The electric work machine according to claim 1, wherein
the second control system includes:
setting a desired rotational speed in accordance with a magnitude of a load being applied to the motor; and
rotating the motor at the desired rotational speed that has been set.

10. The electric work machine according to claim 9, wherein
the second control system further includes:
setting the desired rotational speed to a first speed, based on the magnitude of the load being less than a threshold; and
setting the desired rotational speed to a second speed, based on the magnitude of the load being greater than or equal to the threshold, and
the second speed is greater than the first speed.

11. The electric work machine according to claim 9, wherein
the second control system further includes:
setting the desired rotational speed to a first speed, based on the magnitude of the load being less than a threshold; and
setting the desired rotational speed to a second speed, based on the magnitude of the load being greater than or equal to the threshold, and
the second speed is smaller than the first speed.

12. The electric work machine according to claim 1, further comprising a click feel generator configured to generate a click feel in the second manual switch, in response to the second manual switch moving within the movement range having reached a specific position within the movement range.

13. The electric work machine according to claim 12, wherein
the movement range includes a switching occurrence region, and
the click feel generator is configured to generate the click feel in the second manual switch, in response to (i) the second manual switch having been moved from an outside of the switching occurrence region into the switching occurrence region and/or (ii) the second manual switch having left the switching occurrence region.

14. The electric work machine according to claim 13, wherein
the switching occurrence region extends from a first reference position to a second reference position,
the first reference position is within the second region, and
the second reference position is within the third region.

15. The electric work machine according to claim 1, wherein
the first manual switch includes a trigger, and
the first manual switch being manually operated includes the trigger being moved a distance greater than or equal to a specific distance from an initial position.

16. The electric work machine according to claim 1, wherein the second manual switch includes a lever configured to be pivotally moved by the user.

17. The electric work machine according to claim 1, further comprising a grip configured to be gripped by a single hand of the user, wherein
the first manual switch and the second manual switch are arranged on the grip or in a vicinity of the grip to allow the user to simultaneously operate the first manual switch and the second manual switch by the single hand while gripping the grip by the single hand.

18. A method for controlling a motor in an electric work machine, the method comprising:
rotating the motor in accordance with a first control system, based on (i) a first manual switch being manually operated and (ii) a second manual switch being within a first region;
stopping the motor, based on (i) the first manual switch not being manually operated and/or (ii) the second manual switch being within a second region; and
rotating the motor in accordance with a second control system, based on (i) the first manual switch being manually operated and (ii) the second manual switch being within a third region.
